(19) United States
(12) Patent Application Publication
(10) Pub. No.: US 2018/0277839 A1
(43) Pub. Date: Sep. 27, 2018

(54) MODIFIED SUPER-HYDROPHOBIC MATERIAL-COATED HIGH-NICKEL CATHODE MATERIAL FOR LITHIUM ION BATTERY AND PREPARATION METHOD THEREFOR

(71) Applicant: Shenzhen BTR New Energy Materials Inc., Guangdong (CN)

(72) Inventors: Liang Luo, Guangdong (CN); Shunyi Yang, Guangdong (CN); Xiaozhen Wu, Guangdong (CN)

(21) Appl. No.: 15/764,256

(22) PCT Filed: Sep. 22, 2016
(86) PCT No.: PCT/CN2016/099766

§ 371 Date: Mar. 28, 2018

(30) Foreign Application Priority Data
Sep. 28, 2015 (CN) 201510628492.3

(51) Int. Cl. H01M 4/36; H01M 4/525; H01M 4/505; H01M 4/62; H01M 10/0525; B01J 13/04

(52) U.S. Cl. CPC H01M 4/366; H01M 4/525; H01M 4/505; H01M 2004/028; H01M 4/624; H01M 10/0525; B01J 13/04; H01M 4/625

(57) ABSTRACT

A modified super-hydrophobic material-coated high-nickel cathode material for a lithium ion battery and a preparation method therefor. The surface of the high-nickel cathode material for a lithium ion battery is coated with a modified super-hydrophobic material, and particles are bridged with each other by the modified super-hydrophobic material. The modified super-hydrophobic material is obtained by depositing a nano material on the surface of a super-hydrophobic material. By the surface modification of the super-hydrophobic material, the hydrophobic and electrolyte-philic properties and the conductivity of the super-hydrophobic material are improved. Next the modified super-hydrophobic material is coated on the surface of the particles of the high-nickel cathode material for a lithium ion battery and between the particles, in the form of a three dimensional network. Thus the surface hydrophobic conductive treatment of the high-nickel cathode material is effectively realized; reducing the reaction of environmental water with surface free lithium and side reactions of trace water and an electrolyte, and improving the safety, cycle and storage performance of the high-nickel cathode material for a lithium ion battery in batteries.

### TECHNICAL FIELD

The present invention belongs to the field of cathode materials for lithium ion batteries, in particular to a high-nickel cathode material for a lithium ion battery and a preparation method thereof, more particularly to a modified super-hydrophobic material-coated high-nickel cathode material for a lithium ion battery and a preparation method thereof.

### BACKGROUND ART

With the continuous expansion of applications of lithium ion batteries, higher requirements on energy density, safety and cycle performance of battery materials are put forward.

Cathode active material for a lithium ion battery has a significant impact on the energy density, safety performance and cycle performance of lithium ion batteries. Common cathode active materials for lithium ion batteries are lithium iron phosphate, lithium cobalt oxide, lithium manganese oxide, lithium nickel cobalt manganese oxide, lithium nickel cobalt aluminum oxide, and lithium-rich materials, etc. Among them, high-nickel cathode material is considered as one of the most promising cathode materials.

High-nickel cathode material has advantages such as low price, low toxicity, high specific discharge capacity and high energy density. However, currently, lithium ion batteries with high-nickel materials as cathode materials generally have problems of storage and safety performance, and the cycle performance thereof also needs to be improved. Researches show that residual alkali content on the surface of high-nickel cathode material is on the high side due to the reaction of free lithium on the surface of the material with water and carbon dioxide in the air, and the presence of crystal water and trace water in the high-nickel cathode material results in gas production and safety performance issues of lithium ion batteries with high-nickel materials as cathode materials. Therefore, the improvements of the sensitivity of high-nickel cathode material to water and the safety and cycle performances of lithium ion batteries with high-nickel materials as cathode materials are of great significance.

Currently, the problems of storage and safety performance and cycle performance of lithium ion batteries with high-nickel materials as cathode materials are mainly solved by modification means such as surface coating of metal oxide, surface coating of polymer and surface treatments.

CN101301598A discloses a hydrophobic treatment method of inorganic powder material surface, wherein the inorganic powder material may be lithium nickel cobalt aluminum oxide, lithium cobalt nickel manganese oxide or lithium nickel cobaltate as cathode materials for lithium batteries. The invention completes the hydrophobic treatment on the surface of inorganic powder material by treating the inorganic powder material with a hydrophobizing agent to obtain a wet powder material and then drying the wet powder material under 80-150° C. Wherein, the hydrophobizing agent is one of alcohols, aldehydes, ketones, esters, silanes, or a mixture of at least two of them. This invention solves the problem that inorganic powder materials absorb water in the air during storage, transportation and use under atmospheric environment at normal temperature and pressure or high humidity conditions. Although this invention provides a hydrophobic treatment method for surface of cathode material for lithium ion battery, the hydrophobic material selected by the method is limited, and the hydrophobic treatment is only performed on the surface of the material, an effective coating layer is not formed, and thus it is difficult to solve the problem that trace water in the material occurs side reactions with electrolyte.

CN103392249A discloses a lithium ion secondary battery and a method for manufacturing the same, and the technical points are: the lithium ion secondary battery comprises a cathode formed from a composition comprising an aqueous solvent, wherein the cathode has a cathode current collector and a cathode mixture layer formed on the current collector, and the cathode mixture layer includes at least a cathode active material and a binder, the surface of the cathode active material is coated by a hydrophobic coating, and the binder is a binder that dissolves or disperses in an aqueous solvent. Since the hydrophobic coating is formed by a water-repellent resin, the contact between the cathode active material and the aqueous solvent can be prevented. Although this invention provides a hydrophobic treatment method for surface of cathode material for lithium ion battery, the method is only limited to an aqueous solvent, and the water-repellent resin is simply coated on the surface of the cathode active material. The water-repellent resin can increase the resistance of the cathode active material and is not conducive to the transfer of electrons and ions.

CN102709591A discloses a lithium ion secondary battery, the cathode diaphragm comprises a cathode current collector and a cathode active material layer arranged on the cathode current collector; the surface of the cathode diaphragm or the isolating membrane is coated with a coating of organic hydrophobizing agent. The surface of the cathode diaphragm or the isolating membrane of the lithium ion secondary battery disclosed by the invention is coated with a coating of organic hydrophobizing agent, so that the water content in the lithium ion battery can be effectively reduced, resulting in the reduction of the side reaction caused by water in the working process of the lithium ion secondary battery and the improvements of the cycle performance and the storage performance of the lithium ion secondary battery. However, in this method, an organic hydrophobizing layer is coated on the cathode diaphragm and there is not a coating effect for the inside of the cathode active material, and thus the hydrophobicity between the active materials is limited.

CN102583321A discloses a carbon nanotube/oxide composite membrane with high-specific surface area and a preparation method thereof. The composite membrane has a specific surface area of 100-1800 m²/g, super-hydrophobicity and a network structure. Elongated few-walled carbon nanotubes are arranged interlacedly and form a shelf-like structure and defective multi-walled carbon nanotubes and oxides are mixed and are arranged in gaps of the shelf-like structure. The composite membrane can be used in lithium ion batteries. However, how to use the composite membrane in lithium ion batteries is not concerned. Moreover, when it is used as a membrane structure in a lithium ion battery, a coating effect cannot be achieved on the surface of the cathode active material, and the hydrophobicity between the active materials is also limited.

Therefore, the development of a high-nickel cathode material for a lithium ion battery, which has a better coating effect and achieves better hydrophobic electrolyte-philic properties and higher conductivity of the surface of the high-nickel cathode material for a lithium ion battery, will greatly enhance the storage, safety and cycle performances of the high-nickel cathode material for a lithium ion battery, and provide technical support for wider applications of the high-nickel cathode material for a lithium ion battery.

### CONTENTS OF THE INVENTION

In view of the shortcomings of the prior art, the first purpose of the present invention is to provide a modified super-hydrophobic material-coated high-nickel cathode material for a lithium ion battery, so as to reduce the water content in the pole pieces and thereby improve the safety and cycle performances of a lithium ion battery with high-nickel material as cathode material.

The second purpose of the present invention is to provide a method for coating a high-nickel cathode material for a lithium ion battery with a modified super-hydrophobic material. Surface modification of the super-hydrophobic material improves the hydrophobic and electrolyte-philic properties and conductivity of the super-hydrophobic material. Then the modified super-hydrophobic material is coated on the particle surface of the high-nickel cathode material for a lithium ion battery and between the particles in the form of a three-dimensional network, thereby effectively realizing the hydrophobic and conductive treatment on the surface of the high-nickel cathode material, reducing the reaction of water in the environment with free lithium on the surface and side reaction of trace water with electrolyte, and improving the safety, cycle and storage performances of the high-nickel cathode material for a lithium ion battery in a battery.

In order to achieve the above purposes, the present invention utilizes the following technical solution.

In a first aspect, the present invention provides a high-nickel cathode material for a lithium ion battery, wherein the surface of the high-nickel cathode material for a lithium ion battery is coated with a modified super-hydrophobic material, and particles are bridged with each other by the modified super-hydrophobic material.

The present invention improves the hydrophobic and electrolyte-philic properties and the conductivity of the super-hydrophobic material by modifying the super-hydrophobic material; the modified super-hydrophobic material is distributed in the form of a three-dimensional hydrophobic conductive network on the particle surface of the high-nickel cathode material for a lithium ion battery and between the particles to make coating modification on them, thereby forming a modified super-hydrophobic material-coated high-nickel composite cathode material for a lithium ion battery. The coating of the modified super-hydrophobic material constructs an electrochemically stable interface between electrode material and electrolyte, thereby avoiding the re-absorption of water by particles of the high-nickel cathode material, and thus realizing the hydrophobic and electrolyte-philic properties of the particles of the high-nickel cathode material. Therefore, the modified super-hydrophobic material-coated high-nickel cathode material for a lithium ion battery has excellent hydrophobic and electrolyte-philic properties and conductivity, and improves cycle performance and safety of the high-nickel cathode material for a lithium ion battery.

In the present invention, the modified super-hydrophobic material is a super-hydrophobic material with nano-material deposited on its surface.

In the present invention, nano-material is deposited on the surface of the super-hydrophobic material to form a nano-scale roughness, thereby enhancing the hydrophobic and electrolyte-philic properties and the conductivity of the super-hydrophobic material.

The high-nickel cathode material for a lithium ion battery provided by the present invention is obtained by coating the surface of the high-nickel cathode material for a lithium ion battery with the modified super-hydrophobic material with nano-powder material deposited on its surface, and bridging the particles of the high-nickel cathode material for a lithium ion battery by the modified super-hydrophobic material, to form a composite cathode material of a high-nickel cathode material for a lithium ion battery coated with a modified super-hydrophobic material.

In the present invention, the mass ratio of the super-hydrophobic material to the nano-material is 100:(0.01-50), for example, it may be 100:0.01, 100:0.02, 100:0.05, 100:0.1, 100:0.5, 100:1, 100:5, 100:10, 100:20, 100:30, 100:40 and 100:50, preferably 100:(0.05-10), further preferably 100:0.05.

In the present invention, the mass ratio of the super-hydrophobic material to the nano-material should be controlled such that the mass of the super-hydrophobic material accounts for a large proportion. If the proportion of the super-hydrophobic material is too small, the hydrophobic property will deteriorate. Therefore, in order to achieve the hydrophobization treatment of the surface of the high-nickel cathode material, the proportion of the super-hydrophobic material should be appropriately increased. In the present invention, the mass ratio of the super-hydrophobic material to the nano-material is preferably not less than 100:50.

In the present invention, the super-hydrophobic material is any one selected from the group consisting of super-hydrophobic conductive polymer nanofiber, super-hydrophobic carbon nanotube array film, super-hydrophobic polyacrylonitrile nanofiber, super-hydrophobic carbon fiber film, conductive porous aerogel, and a mixture of at least two of them, preferably any one selected from the group consisting of super-hydrophobic carbon fiber film, super-hydrophobic carbon nanotube array film, super-hydrophobic polyacrylonitrile nanofiber, and a mixture of at least two of them, further preferably super-hydrophobic carbon nanotube array film.

For example, the super-hydrophobic material in the present invention may be only selected from any one of super-hydrophobic conductive polymer nanofiber, super-hydrophobic carbon nanotube array film, super-hydrophobic polyacrylonitrile nanofiber, super-hydrophobic carbon fiber film or conductive porous aerogel, or a combination of two or more of them, for example, a combination of super-hydrophobic conductive polymer nanofiber and super-hydrophobic carbon nanotube array film, or a combination of super-hydrophobic polyacrylonitrile nanofiber, super-hydrophobic carbon fiber film and conductive porous aerogel, or a combination of a super-hydrophobic carbon nanotube array film and super-hydrophobic polyacrylonitrile nanofiber, or a combination of super-hydrophobic carbon nanotube array film and super-hydrophobic carbon fiber film, and the like.

Different super-hydrophobic materials have different hydrophobic effects, and super-hydrophobic carbon nanotube array film and super-hydrophobic carbon fiber film have the best hydrophobic effect. Therefore, the present invention preferably adopts super-hydrophobic carbon nanotube array film and/or super-hydrophobic carbon fiber film.

As a further improvement of the present invention, the nano-material is a nano-powder material.

As a further improvement of the present invention, the nano-powder material is any one selected from the group consisting of nano-alumina, nano-titania, nano-magnesia, nano-zirconia, nano-zinc oxide, and a mixture of at least two of them; preferably any one selected from the group consisting of nano-titania, nano-zirconia, and a mixture of at least two of them; further preferably nano-titania.

For example, the nano-powder material in the present invention may be only selected from any one of nano-alumina, nano-titania, nano-magnesia, nano-zirconia or nano-zinc oxide, or a combination of two or more of them, for example, a combination of nano-alumina and nano-titania, a combination of nano-zirconia and nano-zinc oxide, a combination of nano-titania and nano-zirconia, a combination of nano-titania, nano-magnesia, nano-zirconia and nano-zinc oxide, and the like.

Different nano-oxides have different conductivities, and the conductivities of products using nano-titania and nano-zirconia are relatively better in the present invention. Nano-oxides in the present invention can be further divided into pure nano-oxides or doped nano-oxides, and doped nano-oxides (e.g., zinc oxide is doped with alumina to form N-type conductor with increased conductivity, and the like) have a better conductivity.

As a further improvement of the present invention, the nano-powder material has a median particle diameter of 10-200 nm, for example, 10 nm, 20 nm, 30 nm, 40 nm, 50 nm, 70 nm, 90 nm, 100 nm, 120 nm, 140 nm, 160 nm, 180 nm, 200 nm, preferably 30-100 nm, further preferably 30 nm.

When the median particle diameter of the nano-powder material is 10-200 nm, the size dispersibility of the nano-powder material is better. When the size is larger than the range, the dispersibility becomes relatively poor. When the size is lower than the range, the cost of the nano-powder material is higher.

In the present invention, the high-nickel cathode material is any one selected from the group consisting of lithium nickel cobalt aluminum oxide, lithium nickel cobalt manganese oxide, lithium nickel manganese oxide, lithium nickel cobalt oxide, and a mixture of at least two of them; preferably is any one selected from the group consisting of lithium nickel cobalt manganese oxide, lithium nickel cobalt aluminum oxide, lithium nickel manganese oxide, and a mixture of at least two of them; further preferably lithium nickel cobalt manganese oxide.

For example, the high-nickel cathode material in the present invention may be only selected from any one of lithium nickel cobalt aluminum oxide, lithium nickel cobalt manganese oxide, lithium nickel manganese oxide or lithium nickel cobalt oxide, or a combination of two or more of them, for example, a combination of lithium nickel cobalt aluminum oxide and lithium nickel cobalt manganese oxide, a combination of lithium nickel manganese oxide and lithium nickel cobalt oxide, a combination of lithium nickel cobalt manganese oxide, lithium nickel cobalt aluminum oxide and lithium nickel manganese oxide, and the like.

As a further improvement of the present invention, the high-nickel cathode material has a particle size of 50 nm-100 μm.

As a further improvement of the present invention, the high-nickel cathode material is a surface-coated high-nickel cathode material and/or a doped high-nickel cathode material, preferably a surface-coated high-nickel cathode material.

As a further improvement of the present invention, the coating layer of the surface-coated high-nickel cathode material is any one selected from the group consisting of alumina, titania, magnesia, zirconia, and a mixture of at least two of them; preferably is any one selected from the group consisting of alumina, titania, magnesia, and a mixture of at least two of them; further preferably alumina.

The coating layer of the surface-coated high-nickel cathode material can be selected from any one of alumina, titania, magnesia or zirconia, or in the form of a combination of two or more of them, for example, a combination of alumina and titania, a combination of magnesia and zirconia, a combination of alumina, titania and magnesia, and the like.

As a further improvement of the present invention, the doping element in the doped high-nickel cathode material is any one selected from the group consisting of sodium, aluminum, magnesium, titanium, vanadium, fluorine, and a mixture of at least two of them; preferably is any one selected from the group consisting of aluminum, magnesium, titanium, fluorine, and a mixture of at least two of them; further preferably aluminum.

The doping element in the doped high-nickel cathode material of the present invention can be selected from any one of sodium, aluminum, magnesium, titanium, vanadium or fluorine, or in the form of a combination of two or more of them, for example, a combination of sodium and aluminum, a combination of magnesium and titanium, a combination of titanium, vanadium and fluorine, a combination of aluminum, magnesium, titanium and fluorine, and the like.

In a second aspect, the present invention provides a method for preparing the high-nickel cathode material for a lithium ion battery according to the first aspect, comprising the following steps:

(1) adding a high-nickel cathode material for a lithium ion battery and a modified super-hydrophobic material into a reaction kettle;
(2) uniformly dispersing the modified super-hydrophobic material and the high-nickel cathode material for a lithium ion battery in an ethanol solution;
(3) carrying out solid-liquid separation to the suspension obtained in step (2) and carrying out heat treatment to obtain a modified super-hydrophobic material-coated high-nickel cathode material for a lithium ion battery.

In the present invention, the mass ratio of the high-nickel cathode material for a lithium ion battery to the modified super-hydrophobic material in step (1) is 100:(0.01-5), for example, it can be 100:0.01, 100:0.015, 100:0.02, 100:0.025, 100:0.05, 100:0.1, 100:0.2, 100:0.3, 100:0.4, 100:0.5, 100:0.6, 100:0.8, 100:1, 100:2, 100:3, 100:4, 100:5, preferably 100:(0.25-5), further preferably 100:0.25.

As a further improvement of the present invention, the modified super-hydrophobic material is obtained by depositing nano-material on the surface of super-hydrophobic material.

As a further improvement of the present invention, the deposition is any one selected from the group consisting of vapor phase deposition, liquid phase deposition, electrochemical deposition, and a combination of at least two of them, preferably liquid phase deposition or electrochemical deposition, further preferably liquid phase deposition.

In the present invention, the dispersion in step (2) is any one selected from the group consisting of ultrasonic dispersion, mechanical stirring, spray dispersion, and a combination of at least two of them.

As a further improvement of the present invention, the solid-liquid separation method in step (3) is any one selected from the group consisting of suction filtration, spray drying, stewing, centrifugal separation, and a combination of at least two of them.

As a further improvement of the present invention, the temperature for heat treatment in step (3) is 120-600° C., for example, it can be 120° C., 130° C., 140° C., 150° C., 160° C., 200° C., 250° C., 280° C., 300° C., 350° C., 380° C., 420° C., 520° C., 600° C., preferably 200-600° C., further preferably 200° C. The time for heat treatment is 4-24 h, for example it can be 4 h, 8 h, 10 h, 12 h, 13 h, 15 h, 18 h, 20 h, 21 h, 22 h, 23 h, 24 h, preferably 4-12 h, further preferably 12 h.

As a further improvement of the present invention, the method specifically comprises the following steps:

(1) depositing a nano-material with a median particle size of 10-200 nm on the surface of a super-hydrophobic material to obtain a modified super-hydrophobic material, wherein the mass ratio of the super-hydrophobic material to the nano-material is 100:(0.01-50);
(2) adding a high-nickel cathode material for a lithium ion battery and the modified super-hydrophobic material into a reaction kettle, wherein the mass ratio of the high-nickel cathode material for a lithium ion battery to the modified super-hydrophobic material is 100:(0.01-5);
(3) ultrasonically dispersing the modified super-hydrophobic material into the high-nickel cathode material for a lithium ion battery;
(4) centrifuging and separating the suspension obtained in step (2), and drying to obtain a modified super-hydrophobic material-coated high-nickel cathode material for a lithium ion battery.

In a third aspect, the present invention provides a lithium ion battery comprising the high-nickel cathode material for a lithium ion battery according to the first aspect.

In the present invention, nano-powder material is deposited on the surface of the super-hydrophobic material to form a nano-scale roughness, which improves the hydrophobic and electrolyte-philic properties and the conductivity of the modified super-hydrophobic material. The surface of the high-nickel cathode material for a lithium ion battery is coated with a modified super-hydrophobic material, and particles of the high-nickel cathode material for a lithium ion battery are bridged with each other by the modified super-hydrophobic material. The modified super-hydrophobic material of the present invention is coated on the surface of the particles of the high-nickel cathode material for a lithium ion battery and between the particles in the form of a three-dimensional network, to form a composite cathode material of a high-nickel cathode material for a lithium ion battery coated with a modified super-hydrophobic material. The coating of the modified super-hydrophobic material constructs an electrochemically stable interface between electrode material and electrolyte, thereby avoiding the re-absorption of water by particles of the high-nickel cathode material, and thus realizing the hydrophobic and electrolyte-philic properties of the particles of the high-nickel cathode material. Therefore, the modified super-hydrophobic material-coated high-nickel cathode material for a lithium ion battery has excellent hydrophobic and electrolyte-philic properties and conductivity, and improves cycle performance and safety of the high-nickel cathode material for a lithium ion battery.

Compared with the prior art, the present invention has at least the following beneficial effects:

(1) The modified super-hydrophobic material-coated high-nickel cathode material for a lithium ion battery provided by the present invention has excellent hydrophobic and electrolyte-philic properties and conductivity, and improves the cycle and safety performances of the high-nickel cathode material for a lithium ion battery. Compared with super-hydrophobic material-coated high-nickel cathode material for a lithium ion battery and uncoated high-nickel cathode material for a lithium ion battery, the high-nickel cathode material for a lithium ion battery provided by the present invention has significant advantages in terms of electrolyte-philic property, storage, cycle and safety performances. It has been determined that the modified super-hydrophobic material-coated high-nickel cathode material for a lithium ion battery provided by the present invention has a capacity retention which at least achieves 97.2% after 40 cycles at 1C rate, a weight gain rate which is lower than 0.155 wt % after storage for 60 days under environment having a relative humidity of 80%, and a liquid absorption time which is lower than 2.2 min.
(2) The method for preparing the modified super-hydrophobic material-coated high-nickel cathode material for a lithium ion battery provided by the present invention is simple, easy to operation, and low-cost, and has obvious effects, good repeatability and little environmental pollution, and thus is suitable for industrial production.

### DESCRIPTION OF THE DRAWINGS

FIG. 1 shows a sectional view of the modified super-hydrophobic carbon nanotubes-coated LiNi_{0.6}Co_{0.2}Mn_{0.2}O₂ composite cathode material according to Example 1 of the present invention;

FIG. 2 shows XRD patterns of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material according to Example 1 of the present invention;

FIG. 3 shows first charge and discharge curves of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNiₐ₆Co_{0.2}Mn_{0.2}O₂ cathode material according to Example 1 of the present invention;

FIG. 4 shows cycle performance curves of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material according to Example 1 of the present invention;

FIG. 5 shows storage performance curves of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material according to Example 1 of the present invention;

FIG. 6 shows liquid absorption performance curves of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material according to Example 1 of the present invention.

In the figures: 1—cathode material, 2—super-hydrophobic carbon nanotubes, 3—nano-titania, A—modified super-hydrophobic carbon nanotubes-coated LiNi_{0.6}Co_{0.2}Mn_{0.2}O₂ composite cathode material, B—super-hydrophobic carbon nanotubes-coated LiNi_{0.6}Co_{0.2}Mn_{0.2}O₂ composite cathode material, C—uncoated LiNi_{0.6}Co_{0.2}Mn_{0.2}O₂ cathode material, D—LiNi_{0.6}Co_{0.2}Mn_{0.2}O₂ cathode material.

### EMBODIMENTS

In order to facilitate the understanding of the present invention, examples of the present invention are listed in the following. It should be understood by those skilled in the art that the examples are merely used to help understand the present invention, and should not be construed as specifical limitations to the present invention.

### Example 1

Dibutyl phthalate in a liquid form was gasified and then introduced by N₂ carrier gas into a vapor phase deposition reactor charged with super-hydrophobic carbon nanotubes. The mass ratio of nano-titania to super-hydrophobic carbon nanotube array film was controlled to be 0.05:100, so that the resulting nano-titania (TiO₂) was uniformly deposited on the surface of the super-hydrophobic carbon nanotube array film, to obtain modified super-hydrophobic carbon nanotubes.

The modified super-hydrophobic carbon nanotubes and LiNi_{0.6}Co_{0.2}Mn_{0.2}O₂ electrode material powder having a particle size of 7-60 μm, and super-hydrophobic carbon nanotubes and LiNi_{0.6}Co_{0.2}Mn_{0.2}O₂ electrode material having a particle size of 7-60 μm were dispersed in ethanol solution in a mass ratio of 0.25:100 respectively and mechanically stirred for 1 h, while LiNi_{0.6}Co_{0.2}Mn_{0.2}O₂ electrode material powder was dispersed in ethanol solution and mechanically stirred for 1 h. Then the above three samples were stewed at 200° C. until ethanol solution was completely removed, then solid materials were dried at 400° C. for 12 h to obtain a modified super-hydrophobic carbon nanotubes-coated LiNi_{0.6}Co_{0.2}Mn_{0.2}O₂ composite cathode material, a super-hydrophobic carbon nanotubes-coated LiNi_{0.6}Co_{0.2}Mn_{0.2}O₂ composite cathode material and an uncoated LiNi_{0.6}Co_{0.2}Mn_{0.2}O₂ cathode material.

Uncoated LiNi_{0.6}Co_{0.2}Mn_{0.2}O₂ cathode material is a control experiment, which eliminates that the reasons for improvement is the treatment process and proves that it is coating which improves the properties of cathode material.

Storage performance test: 3-5 g of cathode material sample was weighted in a laboratory room with constant temperature (25° C.) and constant humidity (80% relative humidity) by a 1/10000 balance scale and placed in a weighing bottle which is exposed to air. The sample was weighted once every day until the mass of the sample did not change. Then the sample was weighted once every half a month. The change of the mass of the sample was expressed as weight gain rate. The lower the weight gain rate is, the better the storage performance of the cathode material is.

Liquid absorption performance test of pole pieces: 10 μL of electrolyte was dropped on the surface of the produced cathode pole pieces, and the time required for complete absorption of liquid by cathode pole pieces is the liquid absorption time. The less the liquid absorption time is, the better the electrolyte-philic property of the cathode material is.

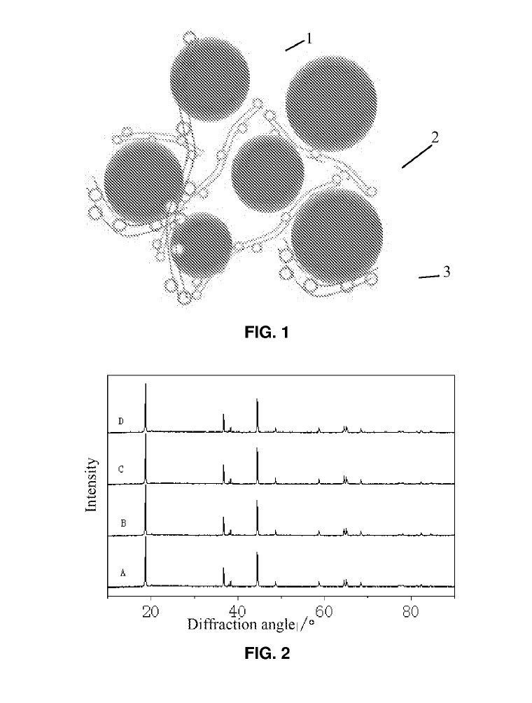

FIG. 1 shows a sectional view of the modified super-hydrophobic carbon nanotubes-coated LiNi_{0.6}Co_{0.2}Mn_{0.2}O₂ composite cathode material according to this example. FIGS. 2, 3, 4, 5, and 6 are respectively XRD patterns, first charge and discharge curves, cycle performance curves, storage performance curves and liquid absorption performance curves of the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material according to this example.

In FIG. 1, nano-titania is deposited on the surface of the super-hydrophobic carbon nanotubes to form a nano-scale roughness. The surface of the high-nickel cathode material for a lithium ion battery is coated with the modified super-hydrophobic carbon nanotubes, and the particles of the high-nickel cathode material for a lithium ion battery are bridged with each other by super-hydrophobic carbon nanotubes.

As can be seen from FIG. 2, all the modified super-hydrophobic carbon nanotubes-coated LiNi_{0.6}Co_{0.2}Mn_{0.2}O₂ composite cathode material, super-hydrophobic carbon nanotubes-coated LiNi_{0.6}Co_{0.2}Mn_{0.2}O₂ composite cathode material, uncoated LiNi_{0.6}Co_{0.2}Mn_{0.2}O₂ cathode material and LiNi_{0.6}Co_{0.2}Mn_{0.2}O₂ cathode material have diffraction peaks of LiNiₐ₆Co_{0.2}Mn_{0.2}O₂.

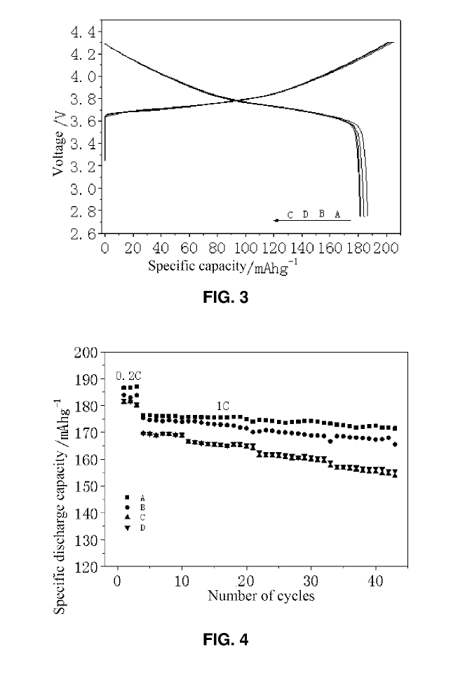

As can be seen from FIG. 3, all the modified super-hydrophobic carbon nanotubes-coated LiNi_{0.6}Co_{0.2}Mn_{0.2}O₂ composite cathode material, super-hydrophobic carbon nanotubes-coated LiNi_{0.6}Co_{0.2}Mn_{0.2}O₂ composite cathode material, uncoated LiNi_{0.6}Co_{0.2}Mn_{0.2}O₂ cathode material and LiNi_{0.6}Co_{0.2}Mn_{0.2}O₂ cathode material have higher first specific discharge capacity.

As can be seen from FIG. 4, the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material have a capacity retention after 40 cycles at 1C rate of 97.2%, 94.4%, 90.6% and 91.8% respectively. This demonstrates that the modified super-hydrophobic carbon nanotubes-coated LiNi_{0.6}Co_{0.2}Mn_{0.2}O₂ composite cathode material has the best cycle performance, the super-hydrophobic carbon nanotubes-coated LiNi_{0.6}Co_{0.2}Mn_{0.2}O₂ composite cathode material has the second best cycle performance, and the uncoated LiNi_{0.6}Co_{0.2}Mn_{0.2}O₂ cathode material has a cycle performance which is comparable to that of LiNi_{0.6}Co_{0.2}Mn_{0.2}O₂ cathode material.

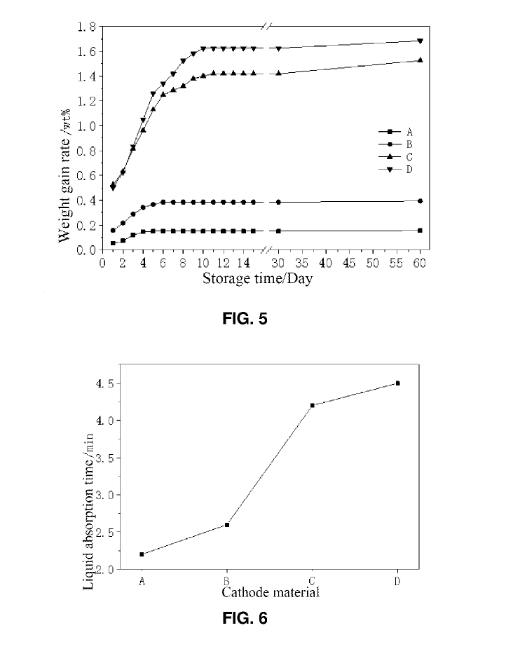

As can be seen from FIG. 5, the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and LiNi_{0.6}Co_{0.2}Mn_{0.2}O₂ cathode material have a weight gain rate after storage for 60 days under environment having a relative humidity of 80% of 0.155 wt %, 0.39 wt %, 1.525 wt % and 1.685 wt %, respectively. This demonstrates that the modified super-hydrophobic carbon nanotubes-coated LiNi_{0.6}Co_{0.2}Mn_{0.2}O₂ composite cathode material has an improved storage performance.

As can be seen from FIG. 6, the modified super-hydrophobic carbon nanotubes-coated LiNi_{0.6}Co_{0.2}Mn_{0.2}O₂ composite cathode material, the super-hydrophobic carbon nanotubes-coated LiNi_{0.6}Co_{0.2}Mn_{0.2}O₂ composite cathode material, the uncoated LiNi_{0.6}Co_{0.2}Mn_{0.2}O₂ cathode material and the LiNi_{0.6}Co_{0.2}Mn_{0.2}O₂ cathode material have a liquid absorption time of 2.2 min, 2.6 min, 4.2 min and 4.5 min, respectively. This demonstrates that the modified super-hydrophobic carbon nanotubes-coated LiNi_{0.6}Co_{0.2}Mn_{0.2}O₂ composite cathode material has a better electrolyte-philic property compared to the LiNi_{0.6}Coₐ₂Mn_{0.2}O₂ cathode material.

### Example 2

0.01 g of nano-zirconia having a particle size of 30 nm-100 nm was added to an ethanol dispersion of 100 g of super-hydrophobic carbon fiber film, and the mixture was strong mechanically stirred for 1.5 h, so that nano-zirconia was fully distributed on the surface of the super-hydrophobic carbon fiber film to obtain a nano-zirconia modified super-hydrophobic carbon fiber film material. 0.5 g of LiNi_{0.815}Co_{0.15}Al_{0.035}O₂ electrode material powder having a particle size of 3-50 μm was dispersed in 20 mL of 10% modified super-hydrophobic carbon fiber film material dispersion and dispersed by ultrasonic wave for 1 hour to make the modified super-hydrophobic carbon fiber film uniformly coated on the surface of the electrode material. After separation by centrifugation, the solid was dried at 200° C. for 12 h to obtain a modified super-hydrophobic carbon fiber film-coated LiNi_{0.815}Co_{0.15}Al_{0.035}O₂ cathode material.

### Example 3

0.01 g of nano-MgO having a particle size of 30 nm-100 nm was added to an ethanol dispersion of 100 g of super-hydrophobic polyacrylonitrile nanofibers, and the mixture was subjected to ultrasonic dispersion for 30 min and then was stewed at 200° C. under mechanical stirring until ethanol was completely removed to obtain a nano-MgO surface modified super-hydrophobic polyacrylonitrile nanofibers. The above modified super-hydrophobic polyacrylonitrile nanofibers and LiNi_{0.8}Co_{0.1}Mn_{0.1}O₂ electrode material powder having a particle size of 10-100 μm were dispersed into ethanol solution in a mass ratio of 0.25:100, and the mixture was mechanically stirred for 30 min, and then spray dried to obtain a modified super-hydrophobic polyacrylonitrile nanofibers-coated LiNi_{0.8}Co_{0.1}Mn_{0.1}O₂ electrode material. Then the electrode material was dried at 200° C. for 24 h to obtain a modified super-hydrophobic polyacrylonitrile nanofibers-coated LiNi_{0.8}Co_{0.1}Mn_{0.1}O₂ cathode material for a lithium ion battery having appropriate water content and specific surface area.

### Example 4

0.01 g of nano-zirconia having a particle size of 40 nm-100 nm and 0.05 g of nano-titania having a particle size of 30-50 nm were added to a dispersion of 100 g of super-hydrophobic carbon nanotube array film, and the mixture was strong mechanically stirred for 1 h, so that nano-zirconia and nano-titania were fully distributed on the surface of the super-hydrophobic carbon nanotube array film to obtain a nano-zirconia and nano-titania modified super-hydrophobic carbon nanotube array film material. 0.5 g of LiNi_{0.815}Co_{0.15}Al_{0.035}O₂ electrode material powder having a particle size of 3-50 μm was dispersed in 20 mL of 10% modified super-hydrophobic carbon nanotube array film dispersion and dispersed by ultrasonic wave for 1 hour to make the modified super-hydrophobic carbon nanotube array film uniformly coated on the surface of the electrode material. After separation by centrifugation, the solid was dried at 200° C. for 4 h to obtain a modified super-hydrophobic carbon nanotube array film-coated LiNi_{0.815}Co_{0.15}Al_{0.035}O₂ cathode material.

### Example 5

0.02 g of nano-zirconia having a particle size of 80 nm-100 nm, 0.25 g of nano-titania having a particle size of 60-80 nm and 0.01 g of nano-magnesia having a particle size of 60-100 nm were added to a dispersion of 100 g of super-hydrophobic carbon nanotube array film, and the mixture was strong mechanically stirred for 1.5 h, so that nano-zirconia, nano-titania and nano-magnesia were fully distributed on the surface of the super-hydrophobic carbon nanotube array film to obtain a nano-zirconia, nano-titania and nano-magnesia modified super-hydrophobic carbon nanotube array film material. 0.5 g of LiNi_{0.815}Co_{0.15}Al_{0.035}O₂ electrode material powder having a particle size of 3-50 μm was dispersed in 20 mL of 10% modified super-hydrophobic carbon nanotube array film dispersion and dispersed by ultrasonic wave for 1 hour to make the modified super-hydrophobic carbon nanotube array film uniformly coated on the surface of the electrode material. After separation by centrifugation, the solid was dried at 200° C. for 4 h to obtain a modified super-hydrophobic carbon nanotube array film-coated LiNi_{0.815}Co_{0.15}Al_{0.035}O₂ cathode material.

### Example 6

0.02 g of nano-magnesia having a particle size of 40-100 nm and 0.1 g of nano-titania having a particle size of 30-100 nm were added to a dispersion of 50 g of super-hydrophobic carbon nanotube array film and 50 g of super-hydrophobic carbon fiber film, and the mixture was strong mechanically stirred for 1 h, so that nano-magnesia and nano-titania were fully distributed on the surface of the super-hydrophobic carbon nanotube array film and super-hydrophobic carbon fiber film to obtain a nano-magnesia and nano-titania modified super-hydrophobic carbon nanotube array film and super-hydrophobic carbon fiber film material. 0.5 g of LiNi_{0.815}Co_{0.15}Al_{0.035}O₂ electrode material powder having a particle size of 3-50 μm was dispersed in 20 mL of 10% modified super-hydrophobic carbon nanotube array film and super-hydrophobic carbon fiber film dispersion and dispersed by ultrasonic wave for 1 hour to make the modified super-hydrophobic carbon nanotube array film and super-hydrophobic carbon fiber film uniformly coated on the surface of the electrode material. After separation by centrifugation, the solid was dried at 400° C. for 8 h to obtain a modified super-hydrophobic carbon nanotube array film and super-hydrophobic carbon fiber film-coated LiNi_{0.815}Co_{0.15}Al_{0.035}O₂ cathode material.

### Example 7

10 g of nano-MgO having a particle size of 60 nm-150 nm was added to an ethanol dispersion of 60 g of super-hydrophobic polyacrylonitrile nanofibers and 40 g of super-hydrophobic conductive polymer nanofibers, and the mixture was subjected to ultrasonic dispersion for 30 min and then was stewed at 200° C. under mechanical stirring until ethanol was completely removed to obtain a nano-MgO surface modified super-hydrophobic polyacrylonitrile nanofibers and super-hydrophobic conductive polymer nanofibers. The above modified super-hydrophobic polyacrylonitrile nanofibers and super-hydrophobic conductive polymer nanofibers and LiNi_{0.8}Co_{0.1}Mn_{0.1}O₂ electrode material powder having a particle size of 10-100 μm were dispersed into ethanol solution in a mass ratio of 0.25:100, and the mixture was mechanically stirred for 30 min, and then spray dried to obtain a modified super-hydrophobic polyacrylonitrile nanofibers and super-hydrophobic conductive polymer nanofibers-coated LiNi_{0.8}Co_{0.1}Mn_{0.1}O₂ electrode material. Then the electrode material was dried at 300° C. for 12 h to obtain a modified super-hydrophobic polyacrylonitrile nanofibers and super-hydrophobic conductive polymer nanofibers-coated LiNi_{0.8}Co_{0.1}Mn_{0.1}O₂ cathode material for a lithium ion battery having appropriate water content and specific surface area.

The applicant states that: the present invention illustrates the detailed method of the present invention by the above examples, but the present invention is not limited to the above detailed method, that is to say, it does not mean that the present invention must be conducted relying on the above detailed method. Those skilled in the art should understand that any modifications to the present invention, any equivalent replacements of each raw material of the products of the present invention and the additions of auxiliary ingredients, the selections of specific embodiments and the like all fall into the protection scope and the disclosure scope of the present invention.

1-11. (canceled)

12. A high-nickel cathode material for a lithium ion battery, wherein the surface of the high-nickel cathode material for a lithium ion battery is coated with a modified super-hydrophobic material, and particles are bridged by the modified super-hydrophobic material.

13. The high-nickel cathode material for a lithium ion battery of claim 12, wherein the modified super-hydrophobic material is a super-hydrophobic material with nano-material deposited on its surface.

14. The high-nickel cathode material for a lithium ion battery of claim 13, wherein the mass ratio of the super-hydrophobic material to the nano-material is 100:(0.01-50).

15. The high-nickel cathode material for a lithium ion battery of claim 13, wherein the super-hydrophobic material is any one selected from the group consisting of super-hydrophobic conductive polymer nanofiber, super-hydrophobic carbon nanotube array film, super-hydrophobic polyacrylonitrile nanofiber, super-hydrophobic carbon fiber film, conductive porous aerogel, and a mixture of at least two of them.

16. The high-nickel cathode material for a lithium ion battery of claim 13, wherein the nano-material is a nano-powder material;
the nano-powder material is any one selected from the group consisting of nano-alumina, nano-titania, nano-magnesia, nano-zirconia, nano-zinc oxide, and a mixture of at least two of them.

17. The high-nickel cathode material for a lithium ion battery of claim 16, wherein the nano-powder material has a median particle diameter of 10-200 nm.

18. The high-nickel cathode material for a lithium ion battery of claim 12, wherein the high-nickel cathode material is any one selected from the group consisting of lithium nickel cobalt aluminum oxide, lithium nickel cobalt manganese oxide, lithium nickel manganese oxide, lithium nickel cobalt oxide, and a mixture of at least two of them.

19. The high-nickel cathode material for a lithium ion battery of claim 18, wherein the high-nickel cathode material is a surface-coated high-nickel cathode material and/or a doped high-nickel cathode material.

20. The high-nickel cathode material for a lithium ion battery of claim 19, wherein the coating layer of the surface-coated high-nickel cathode material is any one selected from the group consisting of alumina, titania, magnesia, zirconia, and a mixture of at least two of them.

21. The high-nickel cathode material for a lithium ion battery of claim 19, wherein the doping element in the doped high-nickel cathode material is any one selected from the group consisting of sodium, aluminum, magnesium, titanium, vanadium, fluorine, and a mixture of at least two of them.

22. A method for preparing the high-nickel cathode material for a lithium ion battery of claim 12, comprising the following steps:
(1) adding a high-nickel cathode material for a lithium ion battery and a modified super-hydrophobic material into a reaction kettle;
(2) uniformly dispersing the modified super-hydrophobic material and the high-nickel cathode material for a lithium ion battery in an ethanol solution;
(3) carrying out solid-liquid separation to the suspension obtained in step (2) and carrying out heat treatment to obtain a modified super-hydrophobic material-coated high-nickel cathode material for a lithium ion battery.

23. The method of claim 22, wherein the mass ratio of the high-nickel cathode material for a lithium ion battery to the modified super-hydrophobic material in step (1) is 100:(0.01-5).

24. The method of claim 22, wherein the modified super-hydrophobic material is obtained by depositing nano-material on the surface of super-hydrophobic material.

25. The method of claim 24, wherein the deposition is any one selected from the group consisting of vapor phase deposition, liquid phase deposition, electrochemical deposition, and a combination of at least two of them.

26. The method of claim 22, wherein the dispersion in step (2) is any one selected from the group consisting of ultrasonic dispersion, mechanical stirring, spray dispersion, and a combination of at least two of them.

27. The method of claim 22, wherein the solid-liquid separation method in step (3) is any one selected from the group consisting of suction filtration, spray drying, stewing, centrifugal separation, and a combination of at least two of them.

28. The method of claim 22, wherein the temperature for heat treatment in step (3) is 120-600° C.; the time for heat treatment is 4-24 h.

29. The method of claim 22, wherein the method comprises the following steps:
(1) depositing a nano-material with a median particle size of 10-200 nm on the surface of a super-hydrophobic material to obtain a modified super-hydrophobic material, wherein the mass ratio of the super-hydrophobic material to the nano-material is 100:(0.01-50);
(2) adding a high-nickel cathode material for a lithium ion battery and the modified super-hydrophobic material into a reaction kettle, wherein the mass ratio of the high-nickel cathode material for a lithium ion battery to the modified super-hydrophobic material is 100:(0.01-5);
(3) ultrasonically dispersing the modified super-hydrophobic material into the high-nickel cathode material for a lithium ion battery;
(4) centrifuging and separating the suspension obtained in step (2), and drying to obtain a modified super-hydrophobic material-coated high-nickel cathode material for a lithium ion battery.

30. A lithium ion battery, comprising the high-nickel cathode material for a lithium ion battery of claim 12.
